(19) United States
(12) Patent Application Publication
(10) Pub. No.: US 2018/0164651 A1
(43) Pub. Date: Jun. 14, 2018

(54) POWER-OFF PROTECTION CIRCUIT AND POWER-OFF PROTECTION METHOD OF ELECTROCHROMIC DEVICE

(71) Applicant: TINTABLE KIBING CO., LTD., Tainan City (TW)

(72) Inventors: JEN-YING FANG, TAINAN CITY (TW); CHIA-HSIU YANG, TAINAN CITY (TW); YI-WEN CHUNG, TAINAN CITY (TW)

(21) Appl. No.: 15/373,820

(22) Filed: Dec. 9, 2016

(51) Int. Cl. G02F 1/163; G02F 1/155

(52) U.S. Cl. CPC G02F 1/163; G02F 1/155

(57) ABSTRACT

A power-off protection circuit and a power-off protection method of an electrochromic device are revealed. A compelling bleached unit is connected to two electrodes of an electrochromic element in parallel. When a power provided to the electrochromic element is turned off, the compelling bleached unit forces the electrochromic element to be bleached by creating a short circuit in the electrochromic element. Thus quality of the electrochromic element will not be affected by the condition that the electrochromic element remains colored and unable to be bleached when the electrochromic element is still in the colored state and the power is suddenly cut-off.

### BACKGROUND OF THE INVENTION

### 1. Field of the Invention

The present invention relates to a power-off protection circuit and a power-off protection method of an electrochromic device, especially to a power-off protection circuit and a power-off protection method of an electrochromic device in which the electrochromic device is forced to be bleached when a power provided to the electrochromic device is turned off for ensuring product quality of the electrochromic device.

### 2. Description of Related Art

Electrochromism is the phenomenon displayed by some materials that are able to reversibly change colour after being applied with voltage. Upon application of the electric field, electrochemical redox reactions occur in electrochromic materials and hence color changes owing to electrons transferred and energy level changed.

Featured on low driving-voltage and bistable characteristics, electrochromic materials have been developed rapidly since 1980s. The electrochromic technology has received more attention and well-developed owing to energy shortage and environmental protection related issues in recent years.

Now the electrochromic materials have been used in energy-saving smart windows for construction, sunroofs and auto-dimming rearview mirrors for automobiles, electronic paper and displays. Thus the electrochromic technology is high competitive, with great potential and having more applications in future.

However, the electrochromic materials remains colored when they are still in the colored state but the circuit is open and no electric field is generated. This has negative effect on the product quality of electrochromic devices.

### SUMMARY OF THE INVENTION

Therefore it is a primary object of the present invention to provide a power-off protection circuit and a power-off protection method of an electrochromic device by which bleaching of the electrochromic device is carried out for protection of the electrochromic device when the electrochromic device is still in the colored state yet the power is cut-off.

In order to achieve the above object, a power-off protection circuit of an electrochromic device according to the present invention includes a colored/bleached control unit, an electrochromic element and a compelling bleached unit. The electrochromic element is connected to the colored/bleached control unit in parallel to form a first parallel loop. The electrochromic element is also connected to the compelling bleached unit in parallel to form a second parallel loop. When the first parallel loop between the electrochromic element and the colored/bleached control unit is open, the compelling bleached unit creates a short circuit between two ends of the electrochromic element. That means the second parallel loop is closed to force the electrochromic element switching to the bleached state. The compelling bleached unit makes the second parallel loop between the compelling bleached unit and the electrochromic element to be open when the first parallel loop between the colored/bleached control unit and the electrochromic element is closed.

The compelling bleached unit is a switch.

The compelling bleached unit can be a relay, a microswitch or a dip switch.

A power-off protection method of an electrochromic device creates a short circuit between two electrodes of the electrochromic device for forcing the electrochromic device to be bleached and switched to the bleached state when the electrochromic device is still in the colored state and no power is supplied to the electrochromic device.

The present invention has the following advantage.

The compelling bleached unit creates a short circuit between two electrodes of the electrochromic device to force the electrochromic device to be bleached when the colored/bleached control unit stops supplying power and the electrochromic device is still in the colored state. Thus the product quality of the electrochromic device will not be affected.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an open circuit between an electrochromic element and a compelling bleached unit when the electrochromic element is provided with power according to the present invention;

FIG. 2 is a schematic drawing showing a short circuit between an electrochromic element and a compelling bleached unit without power supplied to the electrochromic element according to the present invention.

### DETAILED DESCRIPTION OF THE PREFERRED EMBODIMENT

In order to learn technical content, features and functions of the present invention, please refer to the following embodiment, detailed descriptions and related figures.

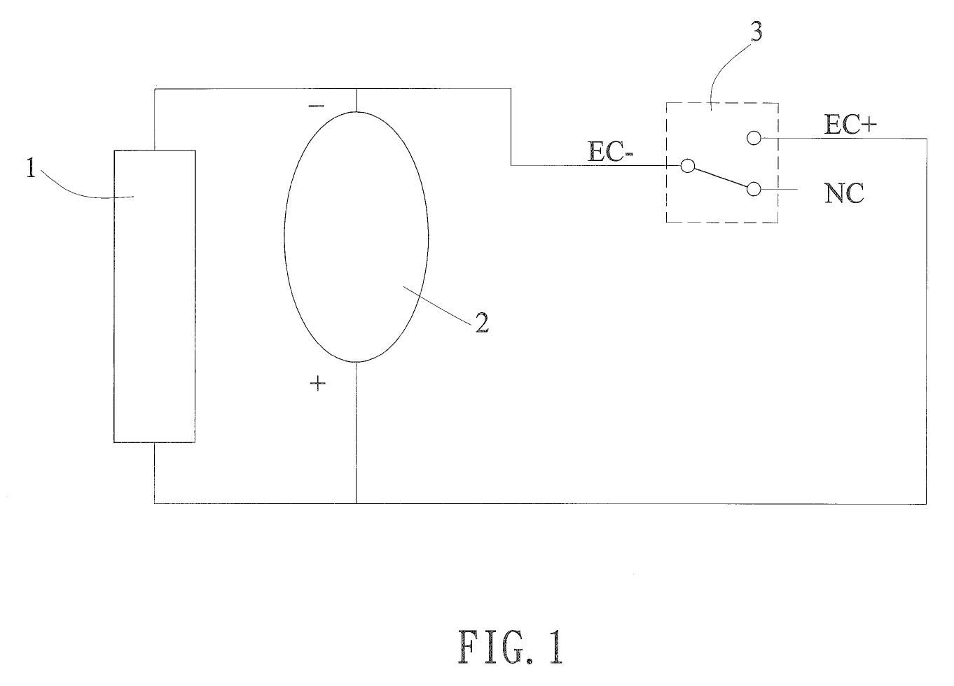

Refer to FIG. 1, a schematic drawing showing a power-off protection circuit of an electrochromic device of the present invention is revealed. The power-off protection circuit of an electrochromic device according to the present invention includes a colored/bleached control unit 1, an electrochromic element 2 and a compelling bleached unit 3.

The electrochromic element 2 includes two electrodes that are connected to the colored/bleached control unit 1 in parallel to form a first parallel loop. The two electrodes of the electrochromic element 2 are also connected to the compelling bleached unit 3 in parallel to form a second parallel loop. The colored/bleached control unit 1 provides power to the electrochromic element 2 and controls colored/bleached timing of the electrochromic element 2. When the colored/bleached control unit 1 stops providing power to the electrochromic element 2 and the electrochromic element 2 is still in the colored state, not bleached yet, the compelling bleached unit 3 creates a short circuit in the second parallel loop and the short circuit occurs between the two electrodes of the electrochromic element 2. Thus the electrochromic element 2 is forced to be bleached.

The compelling bleached unit 3 can be a switch such as a relay, a microswitch or a dip switch.

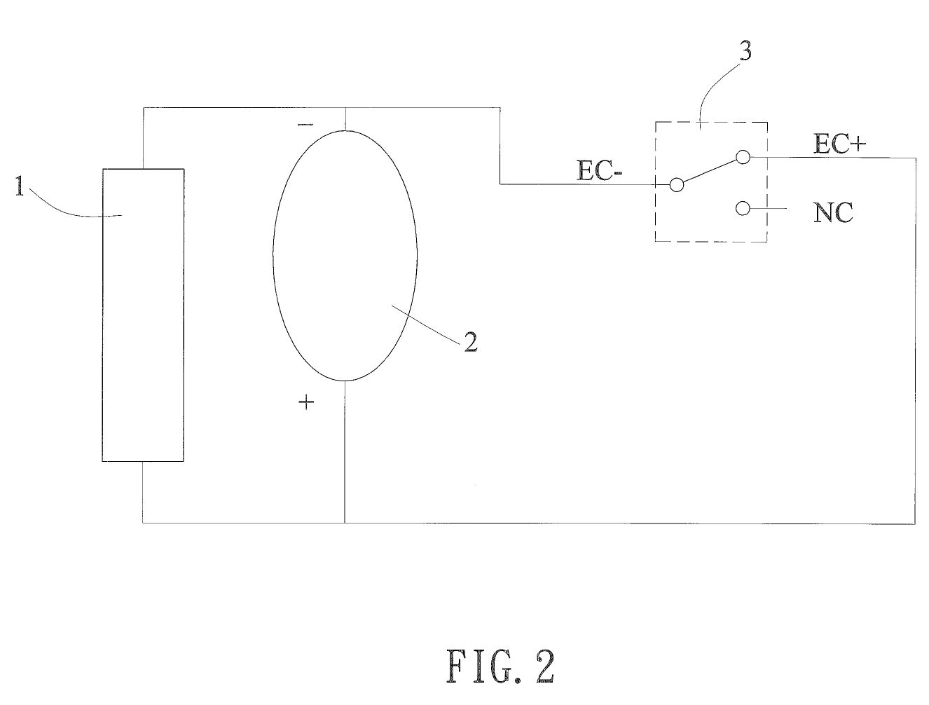

The compelling bleached unit 3 doesn't work and the second parallel loop is open when the colored/bleached control unit 1 provides power for control of switching between the colored state and the bleached state of the electrochromic element 2 (the first parallel loop is closed). However, once the electrochromic element 2 under control of the colored/bleached control unit 1 is still in the colored state and the colored/bleached control unit 1 stops providing power to the electrochromic element 2, the second parallel is closed by the compelling bleached unit 3. That means the compelling bleached unit 3 makes the short circuit occur between the two electrodes of the electrochromic element 2 so that the electrochromic element 2 is forced to be bleached and switched to the bleached state, as shown in FIG. 2.

Although the compelling bleached unit 3 can be selected from the relay, the microswitch, the dip switch, etc. Each switch has a bit difference in actual operation.

When the compelling bleached unit 3 is a relay, the relay makes the second parallel loop in an open state no matter the electrochromic element 2 is in the colored state or the bleached state. Once the electrochromic element 2 is in the colored state and the power is suddenly cut off, the relay automatically turns the second parallel loop into the closed state to cause the short circuit between the two electrodes of the electrochromic element 2 and force the electrochromic element 2 to be bleached.

Users can activate the microswitch manually or turn over the dip switch to make the second parallel loop become closed and the short circuit further occurs between the two electrodes of the electrochromic element when the compelling bleached unit 3 is a microswitch or a dip switch and the electrochromic element 2 in the colored state is not provided with the power.

A power-off protection method of an electrochromic device of the present invention forces the electrochromic element to be switched to the bleached state by creating a short circuit between two electrodes of the electrochromic element when the electrochromic element is still in the colored state and no power is provided to the electrochromic element.

In summary, the compelling bleached unit 3 causes the second parallel circuit to be closed and the short circuit occurs in the two electrodes of the electrochromic element 2 when the electrochromic element 2 is still in the colored state, the colored/bleached control unit 1 stops providing the power to the electrochromic element 2 and the first parallel loop is open. Thus the electrochromic element 2 is forced to be bleached and switched to the bleached state. Therefore the effect of the damage caused by the colored state of the electrochromic element 2 on the product quality when the power is off can be avoided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A power-off protection circuit of an electrochromic device comprising
a colored/bleached control unit,
an electrochromic element, and
a compelling bleached unit;
wherein two electrodes of the electrochromic element are connected to the colored/bleached control unit in parallel to form a first parallel loop; the two electrodes of the electrochromic element are further connected to the compelling bleached unit in parallel to form a second parallel loop; when the first parallel loop between the electrochromic element and the colored/bleached control unit is open, the compelling bleached unit forces the second parallel loop between the compelling bleached unit and the electrochromic element to be closed, and a short circuit occurs between the two electrodes of the electrochromic element; thus the electrochromic element is forced to be switched to a bleached state; the second parallel loop between the compelling bleached unit and the electrochromic element is open when the first parallel loop between the colored/bleached control unit and the electrochromic element is closed.

2. The device as claimed in claim 1, wherein the compelling bleached unit is a switch.

3. The device as claimed in claim 2, wherein the compelling bleached unit is selected from the group consisting of a relay, a microswitch and a dip switch.

4. A power-off protection method of an electrochromic device comprising the step of:
creating a short circuit between two electrodes of the electrochromic element to force the electrochromic element being bleached and switched to a bleached state when the electrochromic element is in the colored state and no power is provided to the electrochromic element.
